(19) United States
(12) Patent Application Publication
(10) Pub. No.: US 2011/0173642 A1
(43) Pub. Date: Jul. 14, 2011

(54) Arrangement for Data Processing Based on Division of the Information into Fractions

(75) Inventors: Rolando Abel MARTIN, Provincia de Buenos Aires (AR); Rodrigo Fernando GRAU, Ciudad de Buenos Aires (AR); Alejo Martin GRAU, Ciudad de Buenos Aires (AR)

(73) Assignee: DIXAR INC. S.A., Ciudad de Buenos Aires (AR)

(21) Appl. No.: 13/007,215

(22) Filed: Jan. 14, 2011

(30) Foreign Application Priority Data
Jan. 14, 2010 (AR) P20100100080

(51) Int. Cl. G06F 9/54

(52) U.S. Cl. 719/328

(57) ABSTRACT

The instant invention comprises a platform engaged to a front end with NET, JAVA, C++ or PYTHON language and a back end provided with a CUBA, a TBB/SSE, an OPEN CL and an IBM Cell.

The operator employs a code enabling access to the platform and this derives, distributes and assigns each task to one of a plurality of processors to distribute calculation and computation of said tasks, such that, once tasks are finished, the operator downloads data obtained stopping the connection with said processors.

### FIELD OF THE INVENTION

The instant invention relates to an arrangement for data processing based on division of the information into fractions and to a process for processing said data.

A preferred embodiment of the invention will described below. This description is merely an example and in no way limits the scope of the invention.

### OBJECT

The instant invention relates to a data processing arrangement which multiples the processing speed as a function of the partition and assignation of information portions such that each of said portions may be processed independently from the remaining ones.

The instant invention provides a development platform enabling a total access of multiple core processors, graphic processors and vector processors integrating them with a pre-existing code.

Therefore, the programmer does not need to change the language, but the arrangement allows programming in any of the languages supported by Microsoft, Net or Framework, such as C• and Visual Basic, or in programming languages such as Java, C++, Python, etc., such as to take advantage of the parallel programming potential.

As such, the invention works with modules depending on the programming language having access to the platform.

These modules, as already mentioned are, for example, NET, JAVA, C++ or PYTHON, are formed by a group of objects and methods which allow the programmer to access the platform.

Also, the arrangement of the invention includes modules depending on hardware resources, i.e. those controlling and having access to a specific hardware device. These modules have also access to the platform.

The group of modules depending on hardware resources is, for example, NVIDIA'S CUDA, INTEL's TBB/SSE, AMD's OPEN CL or IBM Cell.

Now, in order to attain a total access to the different software applications available, the invention includes an interphase which could be considered from two approaches.

The first is considering that the interphase depends on the programming language selected, while the second approach is considering that the interphase is compiled in a language such as plain C exported from a dynamic library (DLL) or from a shared object.

This interphase allows access to computing resources through a multiple device.

The multidevice is a group of computing resources, such as, for example, a plurality of graphic processors working under the same control object.

There are several ways, manual or automatic, for initializing a new multidevice. Thus, if C• is taken in a case of interphase depending on the programming language, initialization of a multidevice groups all graphic processors available in the machine under the same multidevice.

Once one or more multidevices are initialized, vector creation is then a simple task since such multidevice will create multiple NsArrays.

NsArrays may maintain matrixes of different data types, being the types support at present Bool1 and Bool4 from Boolean; Float, Float2 and Float4 from Floating point and Ulnt1, Ulnt4, Int1, Int4, Byte1 and Byte4 from Interger.

Each of said NsArrays forms a base over which parallel programming is performed in the platform such that upon operating them, data to be processed are distributed automatically among the different computing devices handled by the person constructing this particular NsArray.

In equipment with modules depending on hardware resources, and specially those using a PC1 Express channel for interconnecting, data loading and reading from and to NsArrays may be a very expensive operation, therefore general rules of practice recommend loading and reading data few times per computing cycle, the use of a code for loading and computing pre-calculated data being preferred.

Since the platform carries out from common operations as additions and multiplications to more complex operations such as pre-fixed additions and fast Fourier transforms (FFT), these are conditioned by the dimensions of the NsArrays transferred to the operators as well as by the types contained therein.

Different techniques may be used in order to apply certain operations to a sub-assembly of elements of a given NsArray even though Boolean NsArrays act as filters.

Filters may be also considered as a structure allowing some classes of scattering and gathering operations.

Many times it is necessary to implement a function which requires taking advantage of all the power of some of the modules depending on hardware resources, such as in the case in which, for example, it is necessary to reiterate several times through a part of the particular code for computing the estimated distance to an object.

If the case complexity so requires, the programmer may work with the application programming interphase on modules depending on hardware resources, since this interphase facilitates implementing specific functions working with NsArray objects.

This is an exported plain C function using the application programming interphase over modules depending on hardware resources for invoking the call function “CbIntersect”, which finally calls the corresponding module depending on hardware resources.

In this case, a CUDA kernel is applied for solving the problem in the intersection with Julia assembly. The functions of the application programming interphase on modules depending on hardware resources NsGetColumnPtr, NsGetDeviceRowCount and NSGetColumnCount facilitate writing of the code, this resulting in that importation of this code to at least one of the modules depending on hardware resources becomes a very simple task.

Then, conversion of objects from an NsArray to NsArrayHandle native C types takes place.

As an example, when a code of modules depending on hardware resources is being implemented, located in a separate dynamic library, while in a pure C# method operations of the instant invention are used, both calls are integrated in the same code.

Depuration of errors in a device may a very complex task often requiring special hardware and software.

This is not required with the arrangement of the instant invention, since errors are depurated easily with the aid of a standard depurator such as Visual Studio or the like, showing automatically the contents of the arrangement data structures when required by the user.

### SUMMARY OF THE INVENTION

Arrangement comprising at least a platform 1 connected to an application programming interphase 6 depending on the selected programming language or compiled in a language exported from a dynamic library 7 or from a shared object to enable total access of different software applications to multiple core processors 2, graphic processors 3 and vector processors integrating them with a pre-existing code.

Platform 1 is connected to front end modules 4 integrated by a group of objects and methods depending on the programming language and back end modules 5 depending on the hardware controlling and having access to a specific hardware device.

The application programming interphase 6 has access to the computing resources by means of a multidevice 8 which creates multiple NsArrays which in turn create the vectors required for processing, each of said NsArrays forming a base over which parallel programming is carried out in platform 1 such that data to be processed are distributed automatically among the different computing devices handled by the operator creating the particular NsArray.

Said platform 1 carries common and complex operations conditioned by the dimensions of each of said NsArrays transferred to the operators as well as by the types contained therein, so that in order to apply certain operations in a sub-assembly of a given NsArray, different techniques may be used.

Said application programming interphase 6 allows taking advantage of the power of at least one of the modules depending on hardware resources 5 implementing specific functions working with NsArray objects invoking call function “CbIntersect” and the corresponding module code depending on hardware resources 5.

Modules depending on hardware resources 5 facilitate writing of the code, this resulting in importation of the code to at least one of such modules selected between NsGetColumnPtr, Ns GetDeviceRowCount and NSGetColumnCount.

The invention also relates to a process comprised by a step 9 of selection of the language to be used; a coding step 10 creating a code with functions from the dynamic library 7 and a compilation step 11 and execution of the code written in the former step.

Further, the process comprises a new selection step (12) which selects the back end 5 as a function of the task to be carried out; a step 13 detecting platform 1 and hardware analysis detecting processors and grouping them in multiple code processors 2, graphic processors 3 and vector processors, and integrating them by means of the code created in the coding step 10 and a step 14 unifying and creating a design pattern.

The process is also comprised by a step 15 initializing the detected processors; a step 16 loading the RAM memory which is oriented as a function of the detected processors and a new loading step 17 where loading of NsArrays is carried out, which, during an assignation step 18 distributes the information between the detected multiple core processors 2 or graphic processors 3.

The process further comprises a calculation and computing step 19 wherein the information distributed among the detected processors is analyzed and computed thereby to obtain a result which, in downloading step 20, is downloaded to be used, and a disconnection step 21 of processors 2 or 3.

### BRIEF DESCRIPTION OF THE DRAWINGS

FIG. 1 is a schematic flow diagram showing components and their relationship.

FIG. 2 is a schematic view of a platform engaged to a front end and a back end.

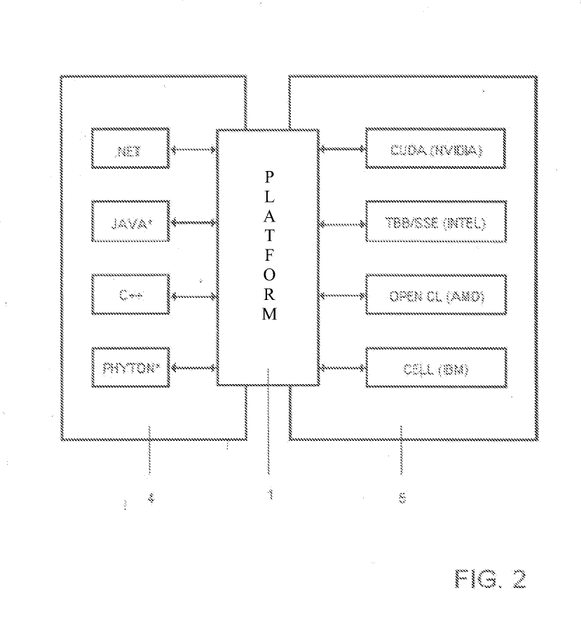

FIG. 3 is a block diagram.

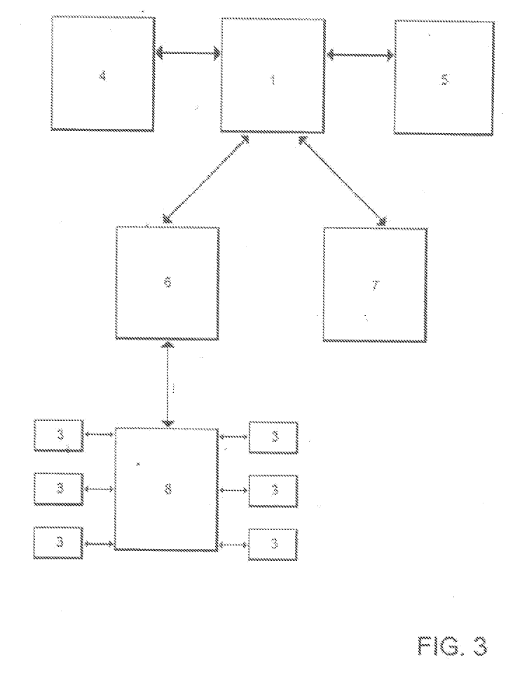

### REFERENCES

Different reference symbols are included in the attached drawings. The same references designate the same or corresponding parts, as follows:

1. Platform

2. Multiple core processor

3. Graphic processor

4. Front end module or module depending on programming language.

5. Back end module or module depending on hardware resources.

6. Application programming interphase.

7. Dynamic library.

8. Multidevice.

9. Selection step.

10. Coding step.

11. Compilation step.

12. New selection step

13. Detection step

14. Unification step.

15. Initialization step.

16. Loading step

17. New loading step

18. Assignation step

19. Calculation and computing step

20. Downloading step

21. Disconnecting step

### Operation

In order to obtain an arrangement for data processing based on division of information into fractions, a platform 1 is provided enabling total access of different software applications to multiple core processors 2, to graphic processors 3 and to vector processors integrating them with a pre-existing code permitting continuation of programming in any Microsoft, .Net or Framework languages, or in Java, C++ or Python languages taking advantage of the parallel programming potential.

To this end, the instant arrangement works with front end modules 4 comprised by a group of objects and methods depending on the programming language having access to platform 1 as well as modules back end 5 depending on hardware resources controlling and having access to a specific hardware device.

The group of back end modules 5 is comprised by, for example NVIDIA'S CUDA, INTEL's TBB/SSE, AMD's OPEN CL or IBM Cell.

In order to attain a total access to the different software applications available, the arrangement includes an application programming interphase 6 which may be considered depending on the selected programming language or may be considered compiled into a language such as plain C exported from a dynamic library 7 or from a shared object.

Interphase 6 has access to computing resources through a multidevice 8 consisting of, for example, a plurality of graphic processors 3 working together under the same control object as a consequence of initialization of said multidevice 8 which creates multiple NsArrays which in turn will create the required vectors for processing.

Since NsArrays may maintain matrixes of different data types, for example Bool1 and Bool 4 from Boolean; float, Float2 and Float4 from Floating point and Ulnt1, Ulnt4, Int1, Int4, Byte1 and Byte4 from Interger, each of said NsArrays forms a base over which parallel programming is carried out in platform 1, such that upon operation thereof, data to be processed are distributed automatically among the different computing devices handled by the operator who creates this particular NsArray.

In equipment with modules depending on hardware resources 5, and specially those using a PC1 Express channel for interconnecting, data loading and computation is effected using a code.

Each platform 1 carries out common and complex operations, therefore these are conditioned by the dimensions of each of the NsArrays transferred to the operators as well as by the types contained therein such as, in order to apply certain operations in a sub-assembly of elements of a given NsArrays, different techniques may be used, the use of filters permitting some kind of operations being preferred.

Among available filters, there are Boolean filters, acting as such the Boolean NsArrays allowing some kind of scattering and gathering operations.

In cases where it is necessary to implement a function requiring to take advantage of all the power of some of the modules depending on hardware resources 5, such as for example reiteration of a code part, the programmer may work with the application programming interphase 6 on modules depending on hardware resources 5, since said application programming interphase 6 facilitates implementation of specific functions working with NsArray objects.

This is an exported plain C function using the application programming interphase over modules depending on hardware resources 5 for invoking the call function “CbIntersect”, which finally calls the corresponding module depending on hardware resources 5.

In this case, a CUDA kernel is applied for solving the problem in the intersection with an assembly. The functions of the application programming interphase 6 on modules depending on hardware resources 5 Ns GetColumnPtr, Ns GetDeviceRowCount and NSGetColumnCount facilitate code writing, this resulting in that importation of this code to at least one of the modules depending on hardware resources 5 becomes a very simple task.

Then, conversion from objects from a NsArray to NsArrayHandle native C types takes place.

For example, when a code of modules depending on hardware resources is being implemented, located in a separate dynamic library 7, while in a pure C# method operations of the instant invention are used, both calls are integrated in the same code.

Depuration of errors in a device may a very complex task often requiring special hardware and software.

This is not required with the arrangement of the instant invention since errors are depurated easily with the aid of a standard depurator such as Visual Studio or the like, showing automatically the contents of the arrangement data structures when required by the user.

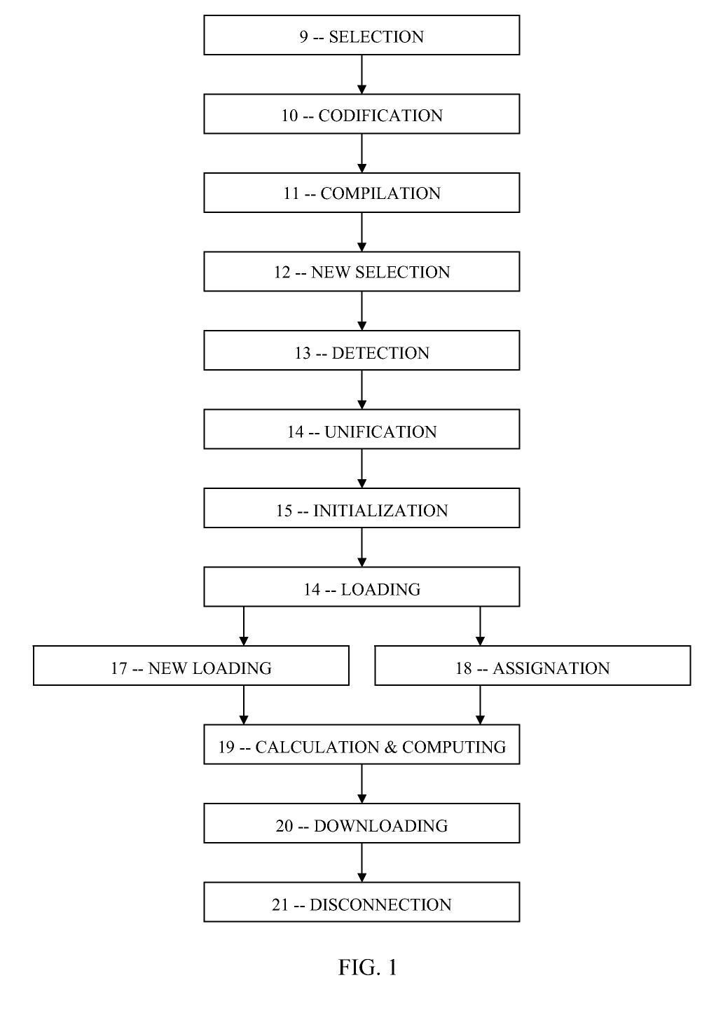

The arrangement of the invention allows carrying out a data processing process in order to optimize the use of resources and accelerate the process. As shown in FIG. 1, the invention comprises a series of steps beginning with a selection step 9 where the programmer decides the language to be used and in a second coding step 10 he writes a code with functions of the dynamic library 7.

In a third compilation step 11, the code written in the former step is compiled and executed, and then, in a new selection fourth step 12, the back end is selected as a function of the task to be carried out.

Then, in a fifth detection step 13 platform 1 analyze the hardware detecting the existing processors for grouping them into multiple core processors 2, graphic processors 3 and vector processors, integrating them by means of the code created in the coding step 10.

In order to maintain calculation and processing uniformity, a design pattern is created in a sixth unification step 14 in order that initialization of processors detected in the fifth step may take place in the seventh initialization step 15.

Loading of RAM memory is carried in the eighth loading step 16.

At this point, loading of RAM memory is directly connected with the type of processors detected by platform 1, since although the following steps are conventional; calculation and processing of the information are not.

Consequently, the RAM memory is directed to multiple core processors 2 or to graphic processors 3.

The ninth new loading step 17 comprises loading NsArrays which, during a tenth assignation step 18, distribute information among the multiple core processors 2 or among graphic processors 3 detected in the detection step 13.

The eleventh step is that of calculation and computing 19, wherein the information distributed among detected processors 2 or 3 is analyzed and computed thereby for obtaining a result that, during the downloading step 20, is downloaded for being used.

The flow diagram includes a last disconnect step 21 in which, upon finishing downloading of data, disconnects the processors.

Having described the preferred embodiment, it will become apparent that various modifications can be made without departing from the scope of the invention as defined in the accompanying claims.

1. Arrangement for processing data based on division of the information into fractions, of the type comprised by at least one multiple core processor, at least one graphic processor and at least one vector processor, characterized by comprising at least one platform connected to an application programming interphase depending on the selected programming language or compiled in a language exported from a dynamic library or from a shared object enabling total access of different software applications to said multiple core, graphic and vector processors integrating them with a pre-existing code; the platform being connected to front end modules comprised by a group of objects and methods depending on the programming language and back end modules depending on the hardware which control and have access to a specific hardware device; the application programming interphase thereof having access to computing resources through a multidevice creating multiple NsArrays which create the vectors required for processing, each of said NsArrays forming a base over which parallel programming is carried out in the platform such that data to be processed are distributed automatically among the different computing devices handled by the creator of that particular NsArray; the platform effecting common and complex operations conditioned by the dimensions of each of said NsArrays transferred to the operators as well as by the types contained therein, so that for applying certain operations in a sub-assembly of elements of a given NsArray, different techniques may be used; the application programming interphase allowing taking advantage of the power of at least one of the modules depending on hardware resources implementing specific functions working with NsArray objects invoking the call function “CbIntersect” and the code of the corresponding module depending on hardware resources, said modules depending on hardware resources facilitating code writing, this resulting in importation of the latter to at least one of such modules selected among NsGetColumnPtr, NsGetDeviceRowCount and NSGetColumnCount.

2. Arrangement as claimed in claim 1, characterized in that the pre-existing code allows continuation of the program in any of the languages supported by Microsoft, Net or Framework, or in Java, C++ or Python languages thus taking advantage of the parallel programming potential.

3. Arrangement as claimed in claim 1, characterized in that the group of back end modules is formed by, among others, NVIDIA'S CUDA, INTEL's TBB/SSE, AMD's OPEN CL or IBM Cell.

4. Arrangement as claimed in claim 1, characterized in that the multidevice is comprised by, for example, a plurality of graphic processors working grouped under the same control object as a consequence of the initialization of said multidevice.

5. Arrangement as claimed in claim 1, characterized in that the application programming interphase is compiled in a language such as plain C.

6. Arrangement as claimed in claim 1, characterized in that the NsArrays may maintain matrixes of different type of data such as, for example, Bool1 and Bool4 from Boolean; float, Float2 and Float4 from Floating point and Ulnt1, Ulnt4, Int1, Int4, Byte1 and Byte4 from Interger.

7. Arrangement as claimed in claim 1, characterized in that filters permitting some kinds of operations are used in order to apply certain operations to a sub-assembly of elements of a given NsArray.

8. Arrangement as claimed in claim 7, characterized in that said filters are Boolean filters, Boolean NsArrays acting as such to permit some types of scattering and gathering operations.

9. Arrangement as claimed in claim 1, characterized in that a CUDA kernel is used to solve the problem of intersection with an application programming interphase.

10. Process for processing data based on division of information intro fractions carried out by the arrangement of claim 1, characterized by comprising the following steps:
a. selection of the language to be used,
b. coding for writing a code having functions of the dynamic library,
c. compilation and execution of the code written in step b,
d. new selection of the back end as a function of the task to be carried out,
e. detection of the platform and analysis of the hardware detecting the existing processors grouping them in multiple core processors, graphic processors and vector processors and integrating them by means of a code created in the coding step,
f. unification and creation of a design pattern,
g. initialization, wherein the detected processors are initialized,
h. loading of RAM memory, oriented as a function of the detected processors,
i. new loading where the NsArray is loaded,
j. new assignation to distribute information among detected multiple core processors or graphic processors,
k. calculation and computation wherein information is distributed among the detected processors, analyzed and computed thereby to obtain a result,
l. downloading of the information to be used,
m. disconnection of processors.
